(19) United States
(12) Patent Application Publication
(10) Pub. No.: US 2007/0119654 A1
(43) Pub. Date: May 31, 2007

(54) Device of an evacuation system

(76) Inventor: Bjorn T. Akselsen, Soreidgrend (NO)

Correspondence Address: Francis C. Hand;Carella, Byrne, Bain, Gilfillan, Cecchi, Stewart, 5 Becker Farm, Roseland, NJ, 07068, US

(21) Appl. No.: 10/569,996

(22) PCT Filed: Aug. 30, 2004
(86) PCT No.: PCT/NO04/00256

§ 371 Date: Jan. 3, 2007

(30) Foreign Application Priority Data
Aug. 29, 2003 (NO) 20033836

(51) Int. Cl. A62B 1/20

(52) U.S. Cl. 182/48

(57) ABSTRACT

There is disclosed a device of an evacuation system, in particular a foldable evacuation means which is arranged to be lowered from a parked folded up position on the vessel to be evacuated to stretched out position on a rescue device, the bottom section of which including a weight device to keep the evacuation means sufficient extended in use position, an including a set of one or more cables/wires connected to a winch arrangement for lowering and lifting the evacuation means. The evacuation device is characterized in that the weight device is arranged to be positioned on the rescue device, and the system includes means to compensate for varying distances between the vessel to be evacuated and the rescue vessel.

The present invention relates a device for securing an evacuation system, such as a rescue stocking, when operated, as will appear in the preamble of the following claim 1.

There is described the work, conclusions and recommendations from the concept development project, evacuation system, in particular for frozen waters. Following the developing, 5 main concepts have been evaluated further. Due to time and reliability, it is recommended to keep as much as possible of well-known and tested system elements. The main system recommended for further development and engineering is a system much based on an existing chute evacuation system, but with a counterweight implemented on the winch wires to keep them and the chute tight in all conditions.

A system as disclosed in the preamble is known from international patent specification WO 94/01324. The winch wires to which the rescue stocking is sliding connected, is kept stretched out by means of the bottom frame connected to the end of the winch wire. The frame extends down below the water surface. The weight of the frame provides for a constant tension of the winch wires.

Reference is also made to international patent specification WO 95/35233.

It is an aim of the invention to present a new structure for obtaining said constant tension of the winch wires.

It is also an aim of the invention to present a new structure where no elements are to be positioned below the se surface. This may be the case where the evacuation system is to be used in frozen waters.

The system of the present invention is characterised by the features appearing in the characterising clause of claim 1.

Preferably a winch arrangement includes means to obtain a constant tension of the cable with the evacuation means in its use position.

Further preferred embodiments of the system of the present invention appear in the dependent system claims.

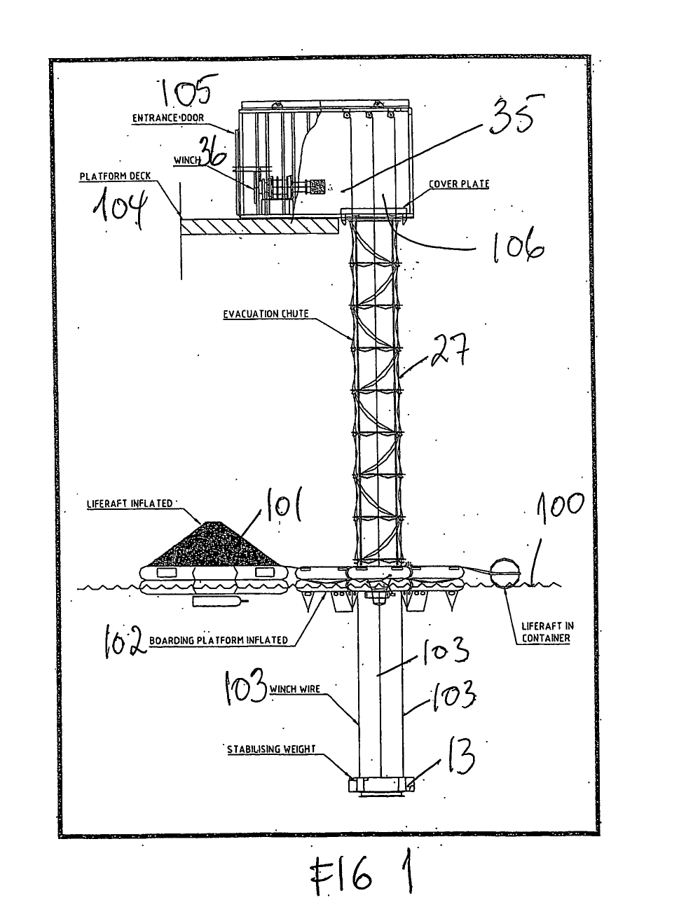

The purpose of the invention in this document is to provide for a evacuation system which may be suitable for offshore platforms operating in frozen waters. The idea behind the project is to be able to evacuation to sea level 100 as shown in FIG. 1, into a system also suitable for evacuation directly to the deck of a vessel in cold and icy conditions. The summer use of the system is planned to be identical to the standard system today with deployment to sea. The winch 36 will then lower the stabilising weight 13 with the life rafts 101 and boarding platform 102 to sea level 100 where the life rafts 101 floats off and the boarding platform 102 automatically inflates. The stabilising weight 13 continues into the sea to a safe distance underneath the boarding platform 102 and the sea level. The sunken weight 13 keeps the stabilising wires 103 (three shown in FIG. 1) tight thereby keeping the chute 27 and the boarding platform 102 in position. FIG. 1 also shows the platform deck 104, the entrance door 105 to the boarding platform 35 in the rescue zone 106. As shown the collapsible chute is guided freely sliding connected to the three (or more) winch wires.

1. Objective

The objective of this work has been to, through a development process, find, evaluate and recommend possible modifications to existing SES-2A chute evacuation system to make this system suitable for evacuation also in frozen waters. The system is required to be operational in both summer and arctic winter conditions. Further details about initial project specifications may be found in appendix 1: “Specification for arctic offshore evacuation system”.

1 Main Challenges

During the first brainstorming meetings, the main challenges were identified and noted:
Keep the chute tight in all conditions of wind, wave and vessel movement.
Operation in low temperatures.
When lowered to deck of a ship, keep the stabilising weight in a fixed position on the deck
When lowered to deck of a ship, avoid any complicated interface to the ship.
When launched to sea, still operate without influence of the modifications
Avoid requirement for external power.
Avoid any permanent extensions below the system floor.
Allow a safe and efficient exit from the chute to the deck of the ship.
Allow a quick and safe disconnection between the deck of the ship and the chute.
   2 Concept Categories

Initially a total of 28 different ideas and solutions were evaluated. The different ideas were first sorted and grouped into which problem they were planned to solve or contribute to solve:
a) Keep chute tight
b) Power supply
c) Fix stabilisation weight on the deck
d) Exit from chute to deck
e) System release from deck

Most of the ideas were related to how to keep the chute tight when evacuating to the deck of a ship. These ideas were again sub grouped into principle of function:
1. Active systems
2. Counter weight systems
3. Spring based systems
4. Bungy cord systems

Another grouping method was also employed. The different ideas were sorted by the method they use to sideways position the chute:
1. Chute guided on tight stabilising wires
2. Chute kept in position of inclined elastic ropes
3. Elastic chute
   3 Decision Criteria.

The list of suggestions was now gradually reduced through a filtering process. The filter used in this process was a list of criteria that was discussed and agreed by the core team. Every suggestion and concept was compared to each criterion on the criteria list. Only those suggestions that passed the criteria were brought further. A second way of filtering that was used was to compare in detail suggestions having similar characteristics and choosing the better of the two alternatives. The filtering processes were continued until only 5 of the original suggestions and ideas were left. The criteria used were as follows:
1. Avoid any solution not based on the principle of tight stabilising wires.
   As we know the system today, to keep the chute guiding wires tight is essential. To keep the chute sideways in position by use of tight stabilising wires is a well-known and tested system. All tested versions till now are based on this. Any other solution will require extensive testing to avoid introduction of unreliable elements.
2. Avoid systems that require modifications of the ship or require special equipment to be available on the ship.
   It was a common opinion of the core team that it would be unwise to limit the connection of the system to special designed or special equipped ships.
3. Avoid dependence on external electric power. Even if the external power source were reliable and redundant, the cables connecting the system to this source would still have to be regarded as vulnerable and the team concluded, based on this, self supplied systems to be more reliable.
4. Avoid systems based on elastic cord or bungy. Again, this was decided due to lack of information and reliable data about previously non-tested components. Implementation of new and untested materials would require extensive testing to be brought up to an acceptable level of reliability. Uncertainties were mainly related to behaviour in cold environments.
5. Comparison of counter weight principles Two of the suggestions left in this stage were pure counterweight systems. One of the systems had the counterweight hanging in the end of the wire while the other had the counterweight hanging in one or more bights of the wire. Advantages and disadvantage were compared for these two systems. The conclusion showed that to arrange the counterweight in bights of the wires is preferable.
6. Elimination of one of two comparable systems Two suggestions, which both were based on existing winch and wire system were compared. Both these systems could be designed to have stabilising wires which were static related to the chute when in operation. The system collecting the superfluous wire inside the stabilising weight was believed to have most disadvantages and was eliminated.

After this process, 5 concept suggestions were left in group a): “How to keep the chute tight”

The invention is to be disclosed in the following with reference to the drawing figures, wherein:

FIG. 1 shows a known system wherein the wire to which the evacuation means is connected, is kept stretched out by means of a stabilising weight connected to the end of the winch wire below the water surface, as disclosed previously in connection with the WO 94/01324.

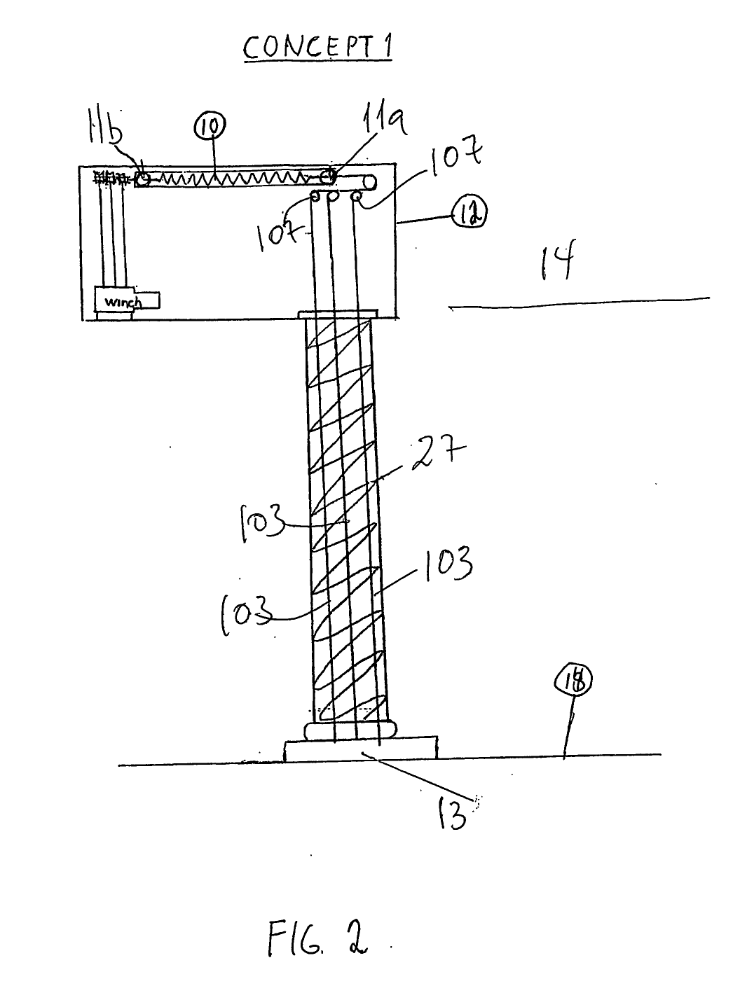

FIG. 2 shows a principle for the system wherein the weight means, according to the invention, has been installed on the deck of the vessel to be evacuated. The system includes a tackle system to compensate for the mutual different movements of a life raft and the rescuing vessel

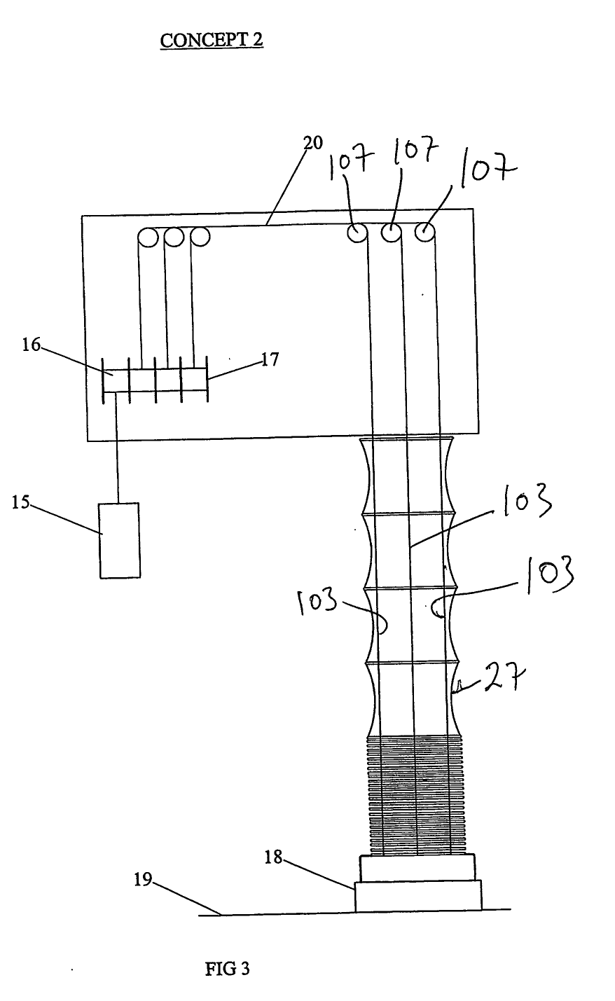

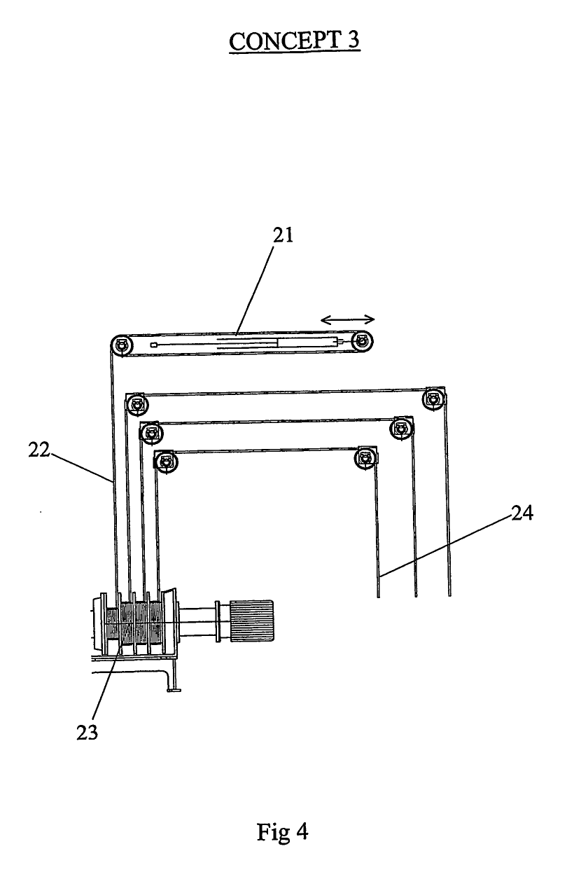

FIG. 3 and 4 shows different embodiments of the idea of the present invention.

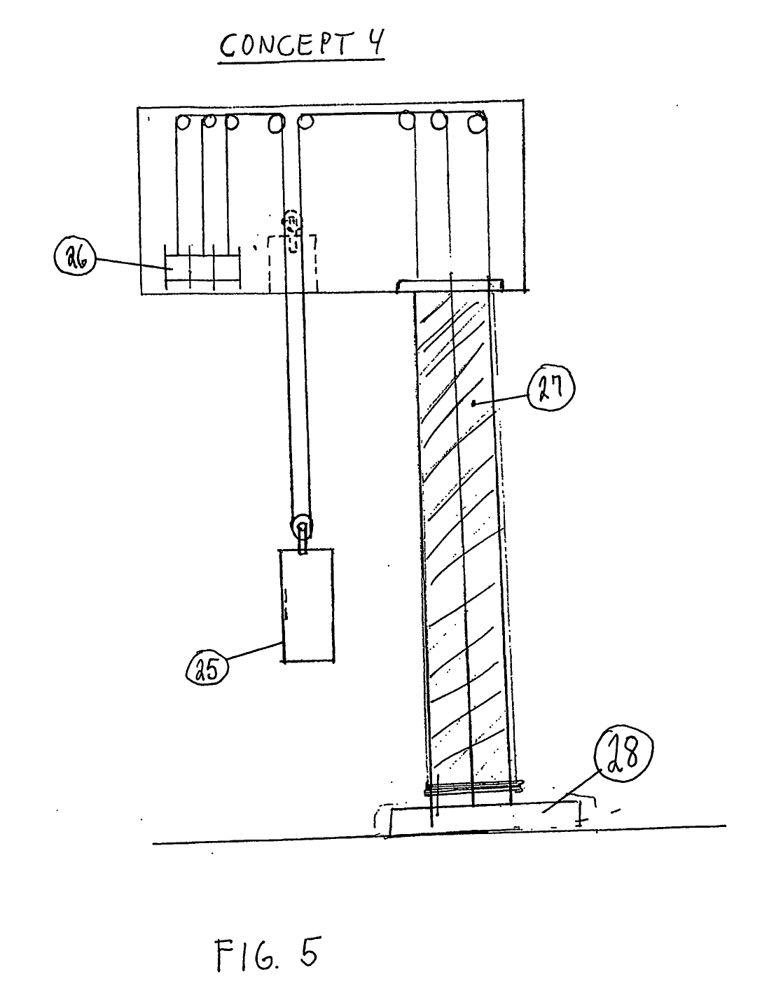

FIG. 5 shows another variant of the system as disclosed in FIG. 2.

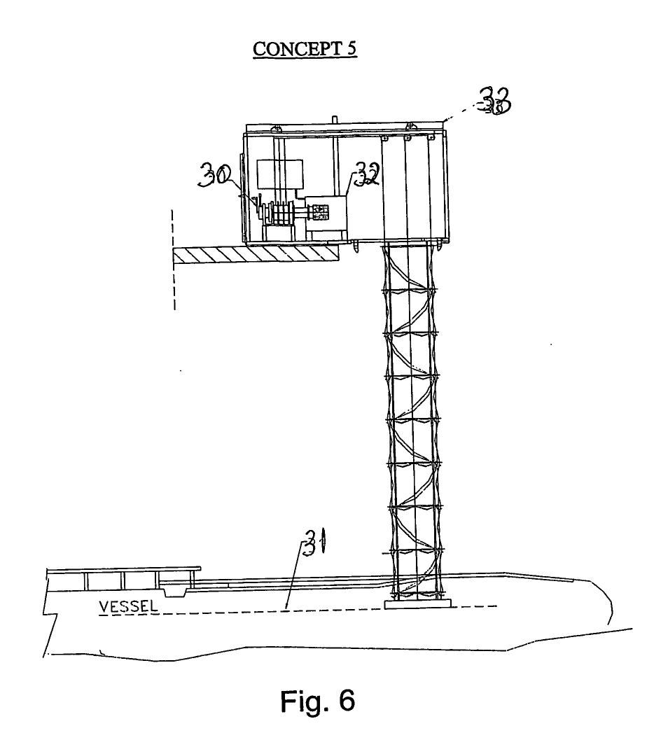

FIG. 6 shows another variant of the system wherein a constant tension winch 30 is used, including a diesel engine or hydraulic pump 32 to provide sufficient hydraulic pressure.

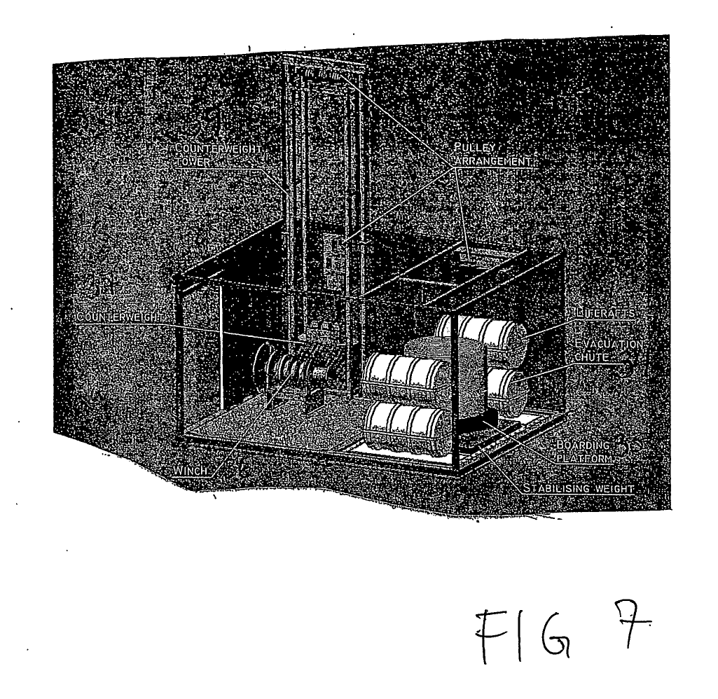

FIG. 7 shows a perspective sketch of the arrangement onboard the vessel to be evacuated

5. General Description and Ranking of the 5 Optional Concepts.

This section gives a description of each of the remaining 5 concepts. In this phase of the study, the engineers worked individually on the 5 concept suggestions with sketching and early stage design work. The purpose with this was to get a better understanding of each concept and discover any major technical problems with implementation of the concepts.

3.1 Multiple Tackle System on the Winch Wires, Concept 1, FIG. 2.

The figure shows the stabilising weight connected to thewinch wires 103. The chute is connected to the wires and weight element 13 as disclosed previously. The wires runs over pulleys to each ones tackle 11. Two tackle systems (first and second) 11a and 11b are mutually separated/expanded by a spring system 10, respectively. The wires from the tackle system 11b is connected to the winch drum. The multiple tackle with system of springs 10 expand the distance between the tackles 11 and by that is able to buffer the superfluous wire. The springs could be mechanical, hydraulic or pneumatic. See FIG. 2. The suitable position for the tackle system should be underneath the ceiling of the container 12 or housing for the whole system. The idea is that the springs are designed to apply a force to the tackle system that is sufficient low for the mass of the immersed stabilising weight 13 to counteract. By this the tackle system will stay compressed until the wires are unloaded by contact between the stabilising weight and the deck of the ship 14. From this point, the tackle system is compensating for the ship movement lifting and lowering down the stabilising weight. A critical operation during deployment would be to stop the winch when the tackles are in correct position.

The following relates to the embodiments of FIG. 2 and 3.

Positive points:
No requirement for external power
All the equipment is compact installed inside the container

Negative points:
Deployment must be stopped in correct position, manually or automatically
The winch drums must have capacity to hold much wire
Difficult to achieve sufficient compensation capacity.
Stabilising wires are moving relatively to the chute
   3.2 Counterweight on Winch, Concept 2. See FIG. 3

This is a counterweight 15 that is connected to a separate shorter wire on a 4^{th} section 16 of the winch drum 17. While lowering, the counterweight is also first lowered until the 4^{th} drum is empty. Further lowering will start re-winding the 4^{th} drum and the counterweight will be hoisted up again to a middle level as the stabilising weight 18 hits the deck of the vessel 19. When in operation, the counterweight will try to rotate the now disengaged winch drum and keep the main wires 103/20 tight. The system requires that it is possible to disengage the winch drum. The deployment-to-deck procedure would include lowering to contact with the deck of the ship and then disengagement of the winch drum. The physical placement of the counterweight would be in a tower going through the roof of the container.

Positive points:
No requirement for external power
Simple and fail safe deployment procedure
Not sensitive to low temperatures.

Negative points:
Must be designed specifically for the actual evacuation height.
Container must be modified with tower for the counterweight.
The standard winch drum must be modified with an extra drum and it must be possible to disengage the total drum.
Stabilising wires are moving relatively to the chute.
   3.2 Tackle System Combined with a 4^{th} Winch Drum, Concept 3. See FIG. 4

This is a combination of concept 1 and 4 above. In this case, the counterweight in concept 4 is replaced by a tackle system 21 as described for concept 1. The loaded tackle system will introduce the required tension in the 4^{th} wire 22 to turn the disengaged winch drum 23 and keep the main wires 24 tight. In parked mode, the tackle system will be compressed. When lowering, the 4^{th} drum will unwind until empty and the tackle system is expanded to its maximum length. Then it will rewind and the tackle system will be compressed to a middle position as the stabilising weight touches the ships deck. The winch drum is then released from the winch brake system.

Positive points:
No requirement for external power
Simple and fail safe deployment procedure
All the equipment is inside the container

Negative points:
Must be designed specifically for the actual evacuation height.
Complex and not very service friendly. The standard winch must be modified. Stabilising wires are moving relatively to the chute.
   3.3 Counterweight on the Main Wires, Concept 4. FIG. 5.

In this system, the counterweight 25 is hanging in bights of the wires between the winch drum 26 and the chute 27. The counterweight is moving vertically in a tower penetrating the roof of the container. To reduce vertical space requirement, the counterweight is connected to the system by means of multiple tackles. The mass of the counterweight would have to be adapted so that the immersed stabilising weight 28 is able to pull the counterweight to upper position. Only when the wires are unloaded by contact between the stabilising weight and the ship's deck 29, the counterweight will start moving downwards. As for concept 1, the critical operation during deployment will be to stop the winch when the counterweight is in the correct position. This may be solved by automatic activation of the winch brake system from a counterweight sensor.

Positive points:
No requirement for external power
Flexible with respect to level of ships deck
Not sensitive to low temperatures

Negative points:
Deployment must be stopped in correct position
The winch drums must have capacity to hold much wire
Stabilising wires are moving relatively to the chute
   4.5 Constant Tension Winch, Concept 5. FIG. 6.

This is a system, which is very similar to today's system, but the electrically powered standard winch is replaced with a constant tension hydraulic powered winch 30. In case of an evacuation to ship's deck 31, this system would not survive a power cut off and need to be fully self-sustained. Emergency power in electric or hydraulic form is supplied from a diesel engine driven unit 32 inside the system container 33. The deployment-to-ship procedure for this system would have to include automatic or manual switching to constant tension mode as soon as the hoisting wires are unloaded.

Positive points:
Simple deployment procedure.
Simple container design
Standard constant tension winch

Negative points:
Backup power required.
Complex and vulnerable system
Stabilising wires are moving relatively to the chute.

In FIG. 7 a perspective sketch of the arrangement onboard the vessel to be evacuated, is shown. Showing the evacuation chute 34, boaring platform 35, winch 36 and counterweights 37, and finally the pulley arrangement 38 mounted into a counter weight tower 39 onboard the ship/vessel.

As the result of an evaluation, a counterweight system having the counterweight in the bights of the wires, is the preferred concept for keeping the chute tight and positioned.

1. Device of an evacuation system, in particular a foldable evacuation means which is arranged to be lowered from a parked folded up position on the vessel to be evacuated to stretched out position on a rescue device, the bottom section of which including a weight device to keep the evacuation means sufficient extended in use position, an including a set of one or more cables/wires connected to a winch arrangement for lowering and lifting the evacuation means, characterized in that the weight device is arranged to be positioned on the rescue device, and the system includes means to compensate for varying distances between the vessel to be evacuated and the rescue vessel.

2. Device according to claim 1, characterized in that the compensation means includes a tackle system.

3. Device according to claim 2, characterized by a multiple tackle (11a,11b) with system of springs (10) that expand the distance between the tackles and by that is able to buffer a superfluous wire (103) of the winch system.

4. Device according to claim 3, characterized by the springs being mechanical, hydraulic or pneumatic in operation (FIGS. 2 and 3).

5. Device according to any of the preceding claims, characterized in that the springs of the tackle system are designed to apply a force to the tackle system that is sufficient low for the mass of the immersed stabilising weight to counteract, so that the tackle system will stay compressed until the wires are unloaded by contact between the stabilising weight and the deck of the ship, thus the tackle system providing a compensating for the ship movement lifting and lowering down the stabilising weight.

6. Device according to any of preceding claims, characterized in that the winch arrangement includes means to regulate the tension of the cable with the evacuation means in its use position.

7. Device according to claim 1, characterized in that the rescue device is a life raft, rescue vessel, or ground.

8. Device according to any of preceding claims, characterized by a system as shown in FIGS. 3, 4, 5 and 6.

9. Device according to claim 1, characterized in that the device is arranged to compensate for (during the evacuation process) varying distance between the entrance to the chute on the vessel to be evacuated, and the exit of the chute on rescue vessel, for example as the vessel are subjected to waves, so as to keep the cable tension mainly constant.

10. Device according to any of preceding claims, characterized in that the evacuation means is an evacuation chute structure inside which the object (i.e. a person) to be evacuated, may slide downwards on the rescue vessel.

11. Device according to any of preceding claims, characterized in that the tension regulating means involves that the winch wires are subjected to counterweight implemented to keep the winch wires tight in all conditions.

12. Device according to claim 11, characterized by the counterweight system is combined with a tackle system.

13. Device according to any of preceding claims, characterized in that the rescue vessel is a life raft floating at a sea level, or a rescuing and/or supply ship, or an ice surface at sea.
